(19) United States
(12) Patent Application Publication
(10) Pub. No.: US 2026/0305539 A1
(43) Pub. Date: Oct. 8, 2026

(54) PRETENSIONED GREENHOUSE PANELS

(71) Applicant: SENSEI AG HOLDINGS, INC., Santa Monica, CA (US)

(72) Inventors: W. Daniel Hillis, Santa Morica, CA (US); Luke Khanlian, Santa Monica, CA (US)

(21) Appl. No.: 19/100,875

(22) PCT Filed: Aug. 1, 2023
(86) PCT No.: PCT/US2023/071401

§ 371 Date: Feb. 3, 2025

Related U.S. Application Data
(60) Provisional application No. 63/371,018, filed on Aug. 10, 2022.

(51) Int. Cl. A01G 9/14; E04C 2/38

(52) U.S. Cl. CPC A01G 9/1407; E04C 2/388

(57) ABSTRACT

Pretensioned panels are provided for use in the construction of a greenhouse, as well as a system for tensioning the panels and configuring the panels into panel arrays. The panels are pretensioned by stretching a transparent or translucent sheet over a rigid frame when the panels are assembled. During installation the panels are dropped in place within a rigid peripheral frame. The resulting assembly forms a complete tensile structure across the surface of the greenhouse.

### CROSS-REFERENCE TO RELATED APPLICATIONS

This application claims priority to U.S. Provisional Application No. 63/371,018, filed Aug. 10, 2022, which is incorporated by reference herein in its entirety by this reference thereto.

### TECHNICAL FIELD

Various of the disclosed embodiments concern pretensioned greenhouse panels.

### BACKGROUND

Greenhouses are used by large commercial operations that specialize in growing vegetables, flowers, trees, and shrubs to be sold for commercial consumption. Crops grown may be sold as retail or wholesale stock. Commercial greenhouses can be very large, covering multiple acres. They are typically permanent structures that can be made of glass, plastic, or other rigid materials or flexible plastic films. These materials are typically transparent or translucent.

Shipping and on-site component fabrication costs, as well as a lack of stability and durability in the finished greenhouse, and limited opportunities for configuration and reconfiguration to suit the greenhouse site and/or crops to be grown make greenhouse design and construction expensive and time consuming. Plastic films typically require stretching, and this can be difficult to control. Many plastic films bond poorly with adhesives and are difficult to attach.

### SUMMARY

Embodiments of the invention provide pretensioned panels for use in the construction of a greenhouse, as well as a system for attaching films, tensioning the panels, and configuring the panels into panel arrays. The panels are pretensioned by stretching a transparent or translucent sheet over a rigid frame when the panels are assembled. During installation the panels are dropped in place within a rigid peripheral frame. The resulting assembly forms a complete tensile structure across the surface of the greenhouse. Thus, individual panels are placed in a surrounding framework and secured thereto, as well as to each other along abutting edges, by connectors to put tension between the panels. This tension overcomes the tendency of the panels to bow inwardly and away from each and adds strength to the resulting structure while making the structure true and rectangular. In some embodiments, this tension can significantly enhance the strength of the attachment of the film to the panel.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows a transparent or translucent sheet for use in a pretensioned greenhouse panel;

FIGS. 2A-2C provide three progressive views that show in FIG. 2A a transparent or translucent sheet aligned with a rigid member and engaged with a transverse rigid member, in FIG. 2B the transparent or translucent sheet is wound about the rigid member to secure the transparent or translucent sheet to the rigid member, and in FIG. 2C the rigid member about which the transparent or translucent sheet is wound abuts the transverse rigid member to define a rectangular greenhouse panel;

FIG. 3 shows a rectangular greenhouse panel formed in accordance with the steps of FIG. 2;

FIG. 4 shows a rectangular panel having an inward bow the occurs due to tensioning of the transparent or translucent sheet;

FIG. 5 shows three rectangular greenhouse panels integrated into an assembly within a rigid frame by a series of connectors;

FIG. 6 shows a matrix of three panel assemblies, each assembly having three panels;

FIG. 7 shows a rigid member to which a transparent or translucent film is secured by a heat weld;

FIG. 8 shows a rigid member about which a transparent or translucent film is wound, where the transparent or translucent film is first wrapped about the rigid member before it is welded to the rigid member;

FIGS. 9A and 9B provide two views in which an upper view (FIG. 9A) shows a perspective of a rigid member about which a transparent or translucent film is wound and to which the transparent or translucent film is secured by an adhesive, and in which a lower view (FIG. 9B) shows a cross section of the transparent or translucent film as secured to the rigid member by an adhesive;

FIG. 10 shows a U-shaped member that is supported by a framework, and which secures within a channel portion thereof two parallel panel assemblies, where the panel assemblies are secured to the U-shaped member by a fastener;

FIG. 11 shows an L-shaped bracket that is supported by a framework, and which secures along a vertical portion thereof two parallel panel assemblies, where the panel assemblies are secured to the L-shaped member by a fastener;

FIG. 12 shows a transparent or translucent sheet secured to a compound member by an adhesive, where the compound member comprises a rigid portion that is partially surrounded by a molded portion;

FIG. 13 shows a section of intersecting, transverse rigid members within a rectangular greenhouse panel;

FIG. 14 shows two rectangular greenhouse panels having a capping member at an intersection thereof; and

FIG. 15 shows two rectangular greenhouse panels engaging with corresponding channel members where the channel members are, in turn, supported by a framework.

### DETAILED DESCRIPTION

Embodiments of the invention provide pretensioned panels for use in the construction of a greenhouse, as well as a system for tensioning the panels and configuring the panels into panel arrays. The panels are pretensioned by stretching a transparent or translucent sheet over a rigid frame when the panels are assembled. Embodiments can use a tool to stretch the transparent or translucent sheet to the frame. During installation the panels are dropped in place within a rigid peripheral frame. The resulting assembly forms a complete tensile structure across the surface of the greenhouse. Thus, individual panels are placed in a surrounding framework and secured thereto, as well as to each other along abutting edges, by connectors to put tension between the panels. This tension overcomes the tendency of the panels to bow inwardly and away from each other and adds strength to the resulting structure while making the structure true and rectangular.

Embodiments allow for prefabrication of the panels and shipping to site without requiring any stretching of the transparent or translucent sheets during the installation at the greenhouse site. All of this is done in a clean, temperature-controlled environment ahead of time versus the state of the art in which transparent or translucent sheets are brought out to the greenhouse site where they are pulled and stretched into existing frames.

During prefabrication the panels are typically bowed inwardly due to the tension applied to the panel framework by the transparent or translucent sheet that is stretched across it. This bowing is addressed when the panels arrive at the greenhouse site, as discussed below, or the panels may be mounted on a carrier that prevents them from bowing after initial assembly and during shipping.

When fabricating a greenhouse in accordance with an embodiment, the panels can be used on the roof and on the walls as well. The panels could be used in a door, vent, etc. Key to this is assuring that the frame into which panels are placed is sufficiently stiff to maintain the tension in the panels.

Because the panels are rigidly held in place and the transparent or translucent sheeting from which they are made is under tension, the fact that the air pressure changes inside the greenhouse does not affect them. The transparent or translucent sheeting attached to the panels does not flop in the wind because of the tension which prevents this. Rather, the panels maintain both their integrity and transparency. Further, the tension likely adds to the structural strength of the entire greenhouse.

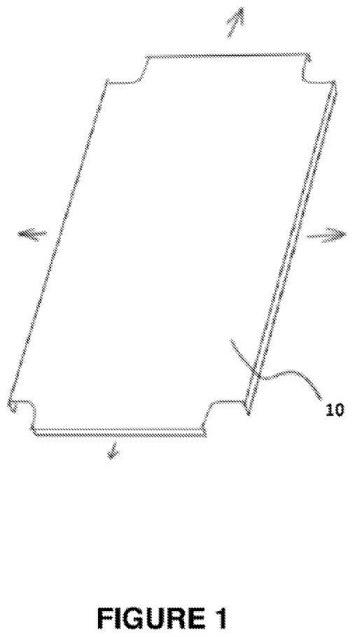

FIG. 1 shows a transparent or translucent sheet 10 for use in a pretensioned greenhouse panel prior to attachment and stretching on a frame. In embodiments, the transparent or translucent material is an ethylene tetrafluoroethylene (ETFE) film. ETFE has a high corrosion resistance and strength over a wide temperature range. Those skilled in the art will appreciate that any stretchable transparent or translucent material may be used to form pretensioned greenhouse panels in accordance with the invention. Note that the corners of the sheet are notched to allow the sheet to be drawn over the frame without having excessive and/or overlapping material at the corners.

In embodiments, the transparent or translucent sheet comprises a single layer material. In alternative embodiments the transparent or translucent sheet may comprise two or more layers of material which may include, for example a pocket of air or an inert gas contained between the layers or disposed on one side of the layers, e.g. a pillow construction.

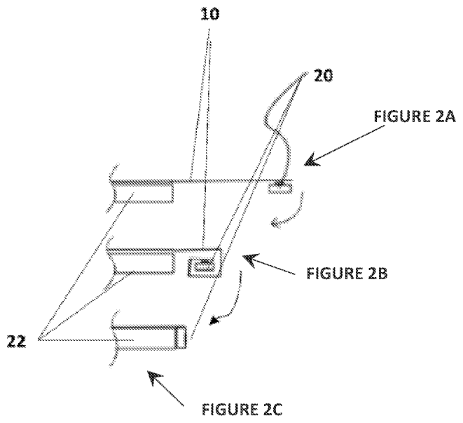

FIGS. 2A-2C provide three progressive views that show in FIG. 2A a transparent or translucent sheet aligned 10 with a rigid member 20 and engaged with a transverse rigid member 22, in FIG. 2B the transparent or translucent sheet is wound about the rigid member to secure the transparent or translucent sheet to the rigid member, and in FIG. 2C the rigid member about which the transparent or translucent sheet is wound abuts the transverse rigid member to define a rectangular greenhouse panel.

Significantly, the transparent or translucent sheet is stretched in two dimensions, e.g. horizontally and vertically, such that it applies tension to the rigid members that form the panel. In this way the panel is pretensioned for installation, as discussed below. To do this the transparent or translucent sheet must be stretched sufficiently to deform the sheet such that it does not revert to its original shape while it is wound about the rigid members that form the panel frame. There are at least two ways to accomplish this.

In a first embodiment, the transparent or translucent sheet is stretched to deform it in each of the horizontal and vertical dimensions such that it does not return to its original shape after being stretched. The deformed transparent or translucent sheet is wound about the rigid members to form a panel. Thereafter, heat is applied to the panel to shrink the transparent or translucent sheet back toward its original shape, thereby tensioning the panel.

In a second embodiment, the transparent or translucent sheet is heated such that it is softened and expanded. The transparent or translucent sheet is then stretched while hot and soft and wound about the rigid members to form the panel. As the transparent or translucent sheet cools it reverts to its original shape and size, thus tensioning the panel.

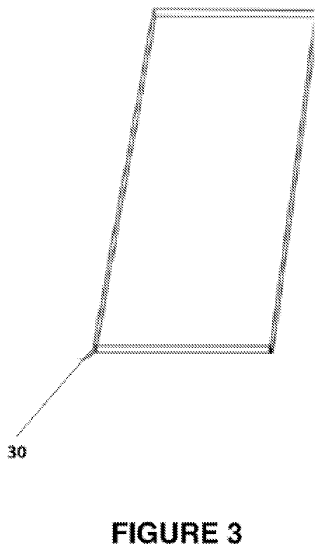

The panel frame comprises a series of rigid members that form a rectangle after the transparent or translucent material is wrapped around the members or otherwise secured to the rigid members. FIG. 3 shows a rectangular greenhouse panel 30 formed in accordance with the steps of FIGS. 2A-2C.

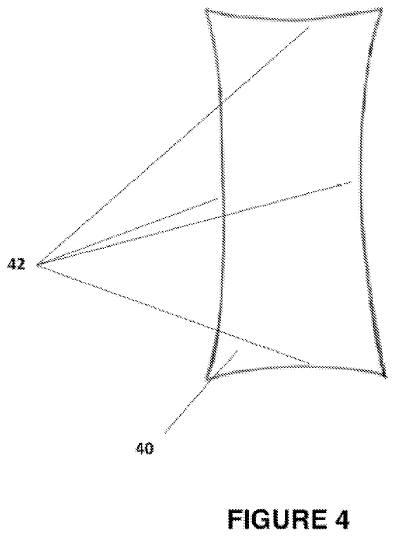

FIG. 4 shows a rectangular panel 40 in which the panel's edges exhibit an inward bow 42 that occurs due to tensioning of the transparent or translucent sheet. In an embodiment, the rigid members comprise vertical bars that are relatively thin strips compared to the overall size of the rectangular panel. The rigid members do not function as a single frame. Hence the bowing. However, when joined to an exterior frame and to each other they become regular rectangles that can cover the entire surface of the greenhouse structure.

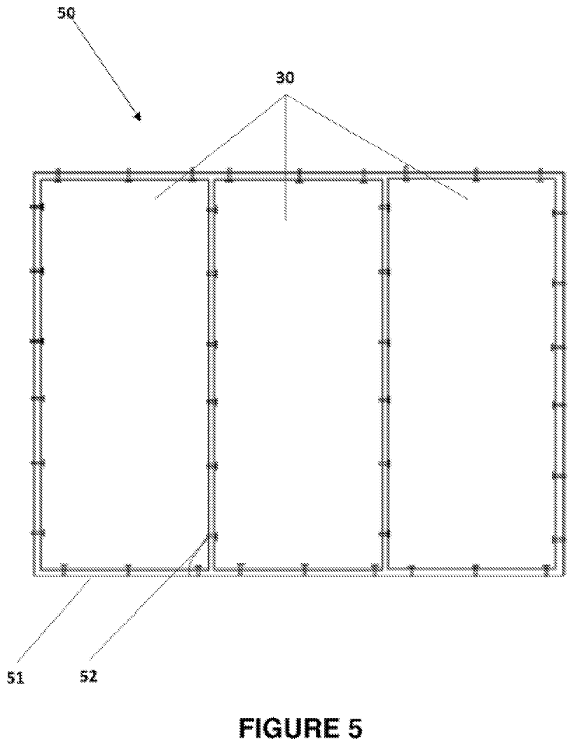

FIG. 5 shows three rectangular greenhouse panels 30 integrated into an assembly 50 within a peripheral rigid frame 51 by a series of connectors 52. The panels initially have an inward bow along their edges as shown in FIG. 4.

The connectors connect one side of a panel to a next panel. The connectors also connect to panels the peripheral rigid frame. The connectors comprise fasteners such as bolts with nuts, metallic rings, wire, or any other material that secures the edges of the panels to the rigid frame and to each other. As discussed below, in embodiments elongate channeled members may be used to guide and secure the panels into an installed position.

Uniquely, each panel stretches the one next to it. Thus, the panels are put in panes and the panes stretch the panels to create a tensile surface across the whole frame in two dimensions.

Accordingly, the rigid frame applies a tension to each panel to straighten and stretch the transparent or translucent sheet in each panel. The panels are attached to the rigid frame by a connector, several of which are shown in FIG. 5.

Significantly, the edges of the panels that do not abut the rigid frame are drawn together by connectors to tension the panels as well and thereby overcome any bowing along the edges of the panels that do not abut the rigid frame. When the assemblies are installed, the tension thus applied traverses the entire greenhouse surface of the structure holding the adjacent panels which are thereby pretensioned to pull each other into a true rectangle.

FIG. 5 shows the panels arranged a vertical dimension, but the panels can also be arranged a horizontal dimension. In FIG. 5 multiple panels are stretched in a 1×3 array in the horizontal dimension. In embodiments, the array can continue in both the x and y axes.

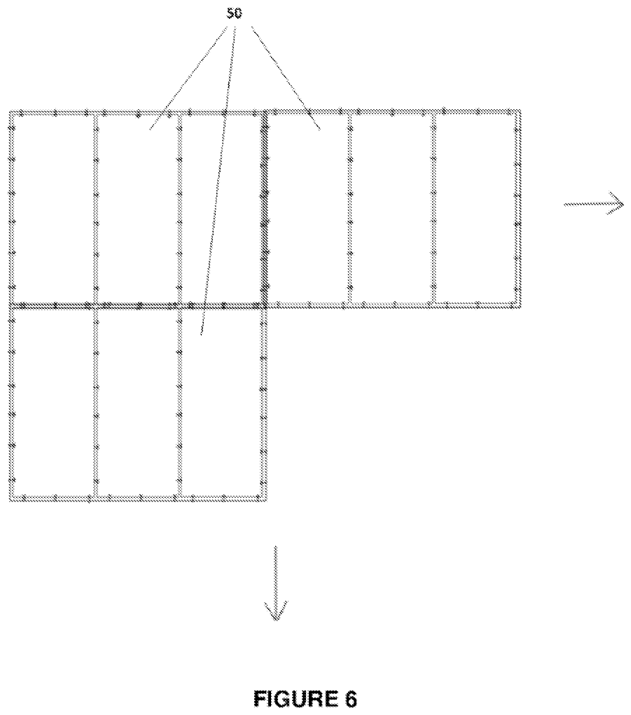

FIG. 6 shows a matrix of three panel assemblies 50, each assembly having three panels as shown in FIG. 5. Horizontal and vertical arrows show that the matrix can be extended as desired. Embodiments permit panel assemblies to be configured as required for the installation. Thus, any N×M matrix can be formed to meet the needs of the greenhouse design.

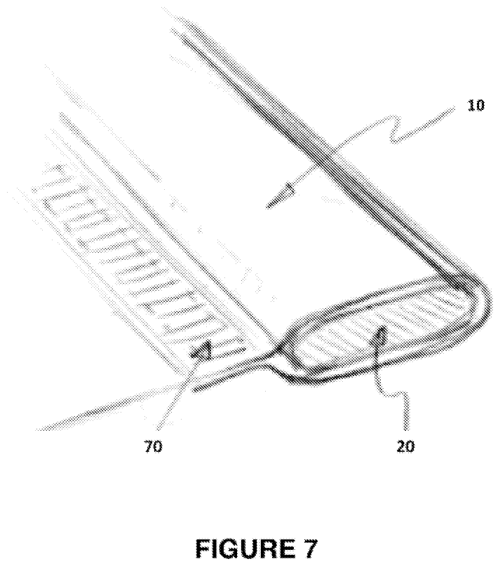

FIG. 7 shows a rigid member 20 to which a transparent or translucent film 10 is secured by a heat weld 70. In embodiments the transparent or translucent sheet is secured to rigid members on all four edges. Each edge of the transparent or translucent sheet is wrapped around a steel, aluminum, or plastic member that comprises a rigid structure or semi-rigid, flexible structure, and then heat welded. The transparent or translucent sheet is then wrapped one or more times around the member. In embodiments the transparent or translucent sheet could be wrapped around a cable, but it is preferred to wrap the transparent or translucent sheet around a bar that comprises a rigid or semi-rigid member. A cable alone would not provide sufficient rigidity to form a pretensioned rectangular greenhouse panel. Thus, instead of a cable that is trapped in another frame, embodiments use a bar that acts as the frame itself. Accordingly, embodiments wrap the transparent or translucent sheet around the bar or member, perform a heat weld, and then perform additional wrapping as desired.

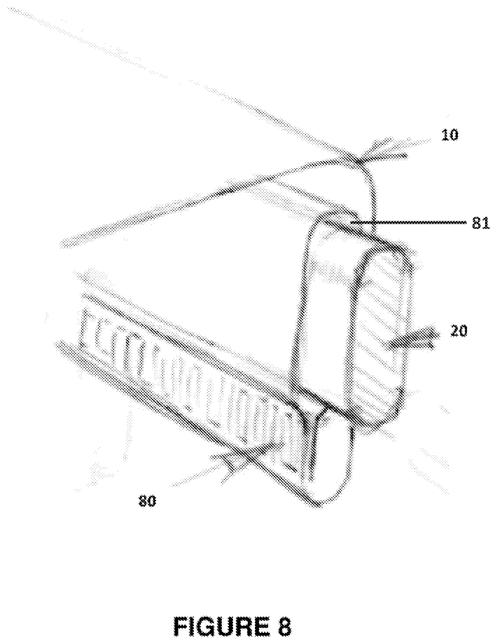

FIG. 8 shows a rigid member 20 about which a transparent or translucent film 10 is wound, where the transparent or translucent film can first be first wrapped about the rigid member or cable within a passage 81 before it is welded 80 to the rigid member. Because the transparent or translucent sheet is first wrapped about the rigid member before the tension in the film creates friction against the rigid member that grows exponentially with the angle of the wrapping this embodiment puts less strain on the heat weld.

In FIG. 8 there is a passage 81 which could accommodate a cable. Here the transparent or translucent sheet is rolled rather than hemmed to leave an open channel and a gap to slide the heat welded looped end of the plastic into entrapping it. The opening is wide enough that the cable and the transparent or translucent sheet can slide into it.

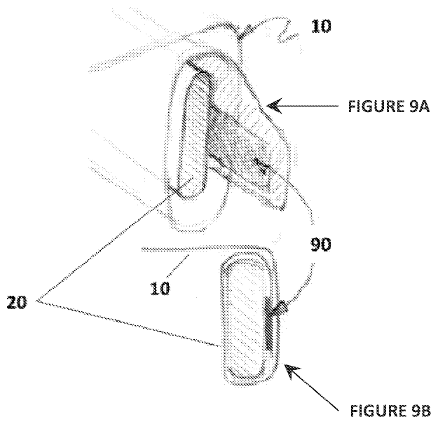

FIGS. 9A and 9B provide two views in which an upper view (FIG. 9A) shows a perspective of a rigid member 20 about which a transparent or translucent film 10 is wound and to which the transparent or translucent film is secured by an adhesive 90, and in which a lower view (FIG. 9B) shows a cross section of the transparent or translucent film as secured to the rigid member by an adhesive. The adhesive in embodiments comprises a low energy adhesive or an adhesive strip that is designed to work with low energy plastics such as ETFE. The adhesive strip is trapped by wrapping the transparent or translucent sheet around the rigid member, thereby reinforcing the bond.

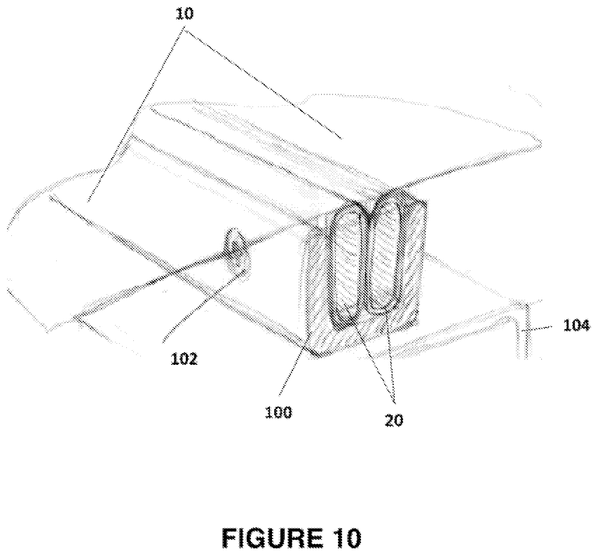

FIG. 10 shows a U-shaped member 100 that is supported by a framework 104 and which secures within a channel portion thereof two parallel panel assemblies, as shown by the respective transparent or translucent sheets 10 and rigid members 20 thereof, where the panel assemblies are secured to the U-shaped member by a fastener 102.

When two rigid members are joined together an adhesive strip is trapped in a channel defined by a U-shaped member or between the two bars. In this embodiment the adhesive does not have to be that strong because most of the force is taken up by the friction as the transparent or translucent sheet wraps around the rigid member. The tension in the film creates friction against the rigid member that grows exponentially with the angle of the wrapping. In this way the friction in the wrapping system secures the transparent or translucent sheet to the rigid member, strengthening the connection.

The fastener can be a bolt and nut, rivet, or any other suitable fastener to secure the panel members within the channel. To accommodate the fastener, holes are drilled through the frame and the adhesive. This is done before the panels and other greenhouse components are shipped. Thus, one of the advantages of this approach is that such fabrication steps do not need to be done on site when the greenhouse is installed. The holes in the various members can be predrilled. Embodiments can also use coin key ended fasteners to poke through the transparent or translucent sheet layers during the final assembly.

FIG. 10 shows the transparent or translucent sheet wrapped once about the rigid member, but it is possible to wrap the transparent or translucent sheet more than once. As shown in FIG. 10, the transparent or translucent sheet for each panel leaves at an opposite side of the U-channel member from each other thereby putting both pieces of the adhesive strip sandwiched against each other, where the fasteners add compressing force. Thus, the assembly is securely held together.

In FIG. 10, the transparent or translucent sheet is wrapped under tension. There are at least two ways of doing this. One is to pull the transparent or translucent sheets into tension while wrapping them. Another way of wrapping the transparent or translucent sheets under tension is to pre-stretch them slightly, wrap them, and then heat treat them back to their original shape.

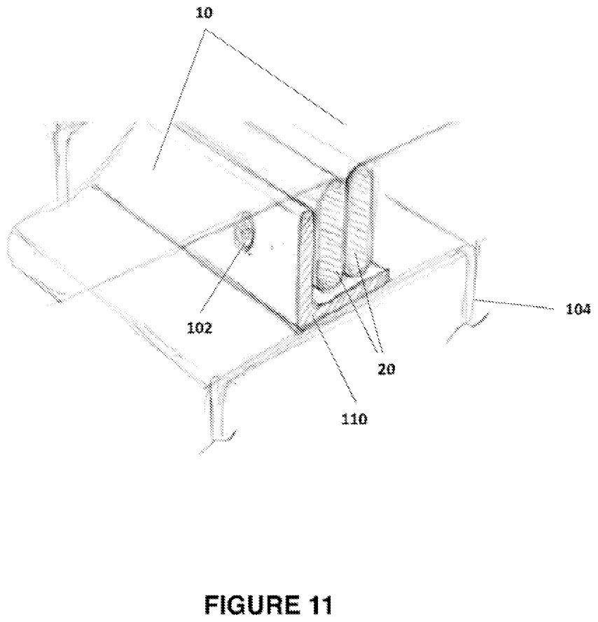

On site, the panels are pushed into the channel, which is already attached to the superstructure or pulled, butted up next to an L-bracket (see FIG. 11) and then bolted in. Accordingly, two lengths of frame for adjacent panels are compressively joined together. Before the panels are pulled together, they are in a bowed configuration due to the tension of the transparent or translucent sheet from which they are formed, as discussed above. The U-channel straightens the rigid members in the panels and finalizes the tension throughout the rest of the transparent or translucent sheet. Thus, the U-shaped member is the tensioning element. The panel members can be secured by fasteners, or they can be pushed into the channel to help locate them within the assembly.

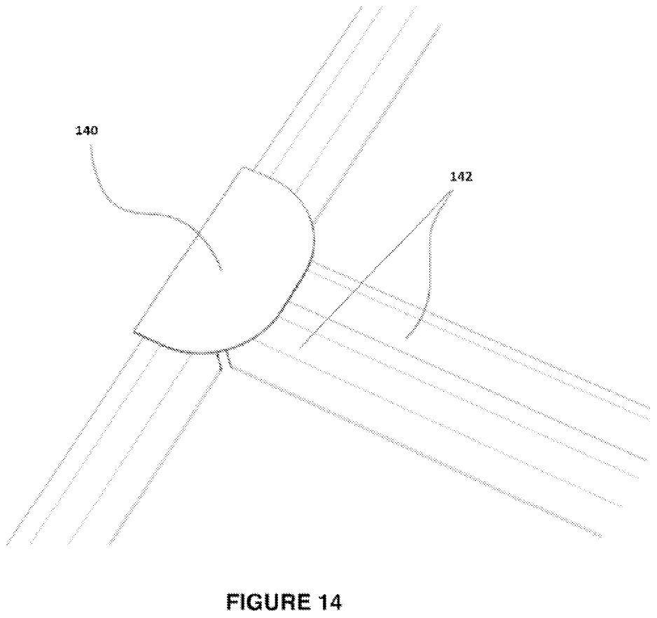

The U-shaped members run transversely to define a rectangular matrix into which the panels are received and secured along each of their four edges. A cap is provided at the corners where the ends of the rigid members in each panel intersect, see FIG. 14.

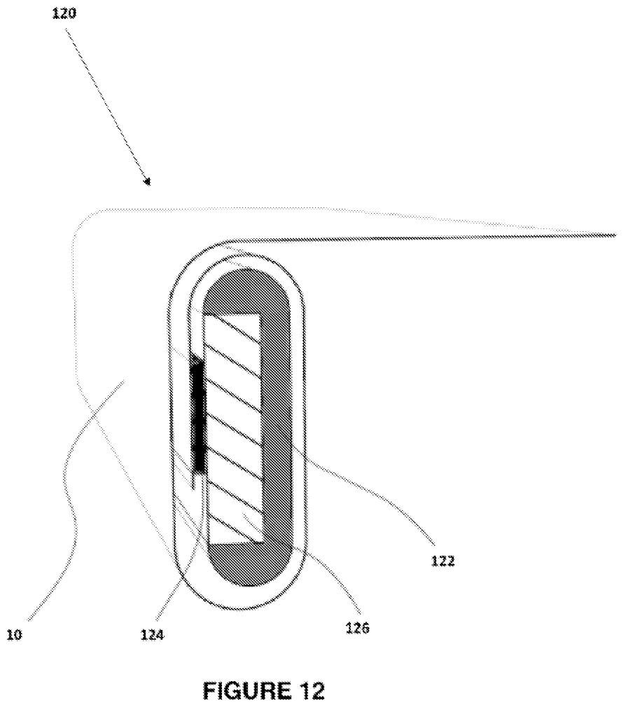

There should not be a gap where the two panel support members abut each other. They are pressed against each other tightly so that water cannot seep through a gap between them. Embodiments can include a strip of rubber or other resilient material positioned between the two panels before they are pressed into the U-channel. To help create that compression there could be a T-shaped piece of rubber. In any event, it is preferred to avoid the possibility of water seeping into the greenhouse through a gap between the abutting panels. Thus, embodiments could use a neoprene cover (see FIG. 12) that is resilient enough to provide a moisture seal between the panels. Embodiments could also use caulk to seal the gap, although this would not be preferred if it was later desired to dismantle the greenhouse and move it. Significantly, there is likely to be moisture within the greenhouse that could affect the U-channel and it is therefore preferred to provide a waterproof seal between the panels, e.g. where the U-channel squeezes the panel members into a compressive abutment.

In embodiments it is possible to make the entire greenhouse from the same material, e.g. rolled steel is preferrable. This embodiment could use a hemmed edge of steel that traps each edge of the transparent or translucent sheet in one wrap using a small piece of U-channel (see FIG. 10). This embodiment uses less material in total. In embodiments a trapped cable extends along into a curled edge of the transparent or translucent sheet. The cable slides into the fold of the transparent or translucent sheet edge and the resulting assembly slides into a U-channel profile.

FIG. 11 shows an L-shaped bracket 110 that is supported by a framework 104 and which secures two parallel panel assemblies along a vertical portion thereof, as shown by the respective transparent or translucent sheets 10 and rigid members 20 thereof, where the panel assemblies are secured to the U-shaped member by a fastener 102 FIG. 12 shows a transparent or translucent sheet 10 secured to a compound member 120 by an adhesive 124, where the compound member comprises a rigid metal portion 126 that is partially surrounded by a molded plastic portion 122. In this embodiment the compound member comprises a rectangular bar that has a cover of plastic, such as neoprene, that may also have elastomeric properties. The cover creates a soft edge for the transparent or translucent sheet to wrap around. In embodiments the plastic cover is slipped into a complementary depression formed within the metal bar, or it may be molded in contact with the bar. The plastic cover may have a high coefficient of friction to prevent slippage of the transparent or translucent sheet. In this case the metal bar provides rigidity, while the plastic cover mitigates the bending angle over which the transparent or translucent film is bent, i.e. a more generous radius. The plastic cover is held in place by the friction of the tightness on the film or it could be bonded to the metal bar. The cover could also be a plastic molded piece with a slight tension. Once the metal bar and cover are assembled transverse fasteners may also be provided to secure the metal bar and cover together.

Significantly, the combination of the two materials provides both rigidity and a rounded edge.

Further, this combination provides both a good surface via the metal bar to which the edge of the transparent or translucent sheet may be glued and a high friction surface via the cover around which to wrap the transparent or translucent sheet. Thus the metal surface is better for gluing to than the neoprene cover because it is stronger, but the neoprene cover has a higher coefficient of friction. Further, when pressed into the U-channel frame, see FIG. 10, the cover adds additional surface compression along a sealing edge.

The metal bar could be made of aluminum or steel or may be a non-metallic material if it possesses sufficient rigidity. Further, the metal bar could made be of the same material as that of the U-frame and underlying greenhouse structure. In this way the coefficient of expansion for greenhouse would be consistent throughout the structure. Embodiments could have all metal components made of hot dipped galvanized steel, which is an economical choice.

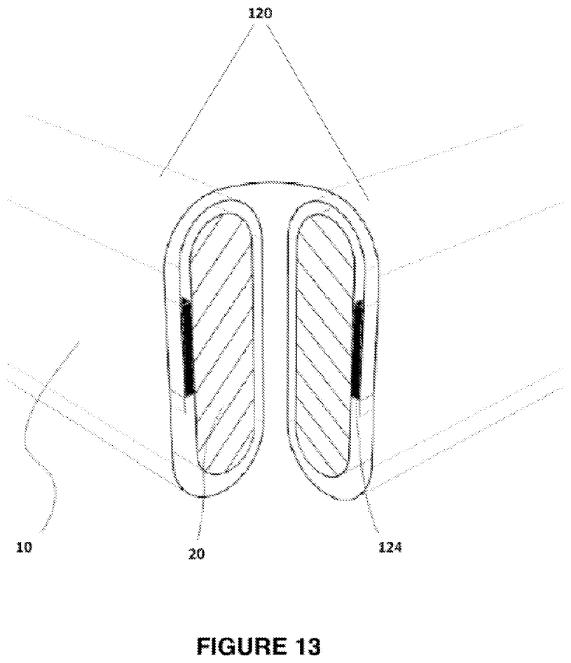

FIG. 13 shows a section of intersecting, transverse rigid members 120 within a rectangular greenhouse panel.

FIG. 14 shows two rectangular greenhouse panels 142 having a capping member 140 at an intersection thereof. The capping member can comprise a simple covering that covers a T-joint at the point where the ends of two panels converge with each other. The cover can comprise a neoprene bottom that is fastened into a corner block, e.g. by fasteners such as screws.

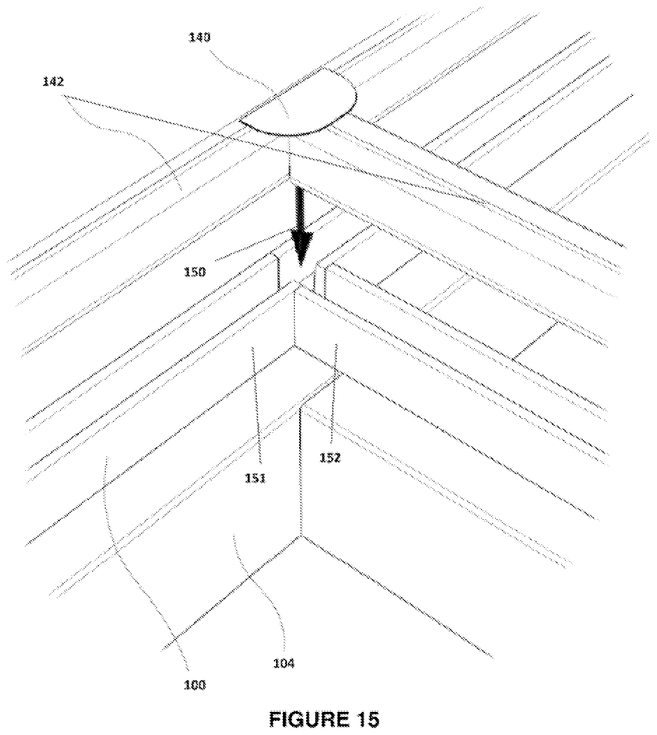

FIG. 15 shows two rectangular greenhouse panels 142 engaging with corresponding channel members 100, as shown by the arrow 150, where the channel members are, in turn, supported by a framework 104. The channels receive two abutting panels, see FIG. 10.

In FIG. 15 there are two channels 151, 152 that are perpendicular to each other. The channels are the mechanism that holds the panels to the superstructure. In embodiments the channels are individual bars that are configured in such a way that they snap or clip together to form a rectangle or they can be formed as rectangles in advance, e.g. with welded edges.

The edges of the panels slip into the channels. Each rectangular panel frame is joined at the corners, even if they are only joined temporarily during shipping, in which case dropping the panel into the channels on the superstructure then serves to secure the rectangular configuration of the panel. Each corner comprises a T-junction. The channels terminate slightly before the T-junction. As mentioned above, a cover secures the panel in the channels.

In the case where there is no adjoining panel, the channel is narrower to accommodate a single panel and a connection to greenhouse structure.

When the rigid elements are folded at right angles to the primary surface of the panel, a gap may be created at the corner, as shown in FIG. 13. When the panel is placed into a U-channel a compressible plug may be pressed into this to seal the corner as shown in FIGS. 13 and 14.

The four rigid members that comprise the panel tension each other adjacent from each other. The rigid members then fit into an attachment, such as the channels described above, to the superstructure. The superstructure provides the end tension where the edges are against the superstructure.

In embodiments the panels are provided in standard sizes to simplify manufacture, greenhouse design, and shipping. Those skilled in the art will appreciate that the panels may be any desired size. In embodiments the channels, the panels, and the superstructure all are provided in standard sizes and the greenhouse can easily be configured as desired.

A temporary stretcher holds the panels in a true, stretched, i.e. unbowed, position. The stretcher can be applied prior to shipping, or it can be installed to the panel onsite on site. The panel is dropped in place, as discussed above, in the true position and then the stretcher is removed. The lightweight flexible panel frames can be put in a handling frame for shipping, for handling, or to retain the panels in their final shape before they are installed in the channels.

In embodiments a specialized panel could have a hinge to allow the panel to be used for ventilation. Such embodiment could have a perimeter U-channel where a single panel could drop into the perimeter U-channel, where the U-channel is mounted to a vent hinged frame section. In this embodiment the U-channel could mount to the hinged portion, or it could be the hinged portion. In embodiments the panel could cover a vent frame. In this embodiment the vent frame should be built stiff enough to tension the panel.

As the panels are assembled into rows in the greenhouse it is not desirable that the tension, e.g. the bow, accumulates until the last panel is installed in a row. In embodiments, at the beginning of panel installation one or more dummy panels made of a stiff material can be installed in place of the transparent or translucent panels as blanks first, after which the transparent or translucent greenhouse panels themselves may be installed in sequence. To do so, an installer removes a blank panel and installs a stretched panel in its place. In this embodiment the blank panels maintain a true relationship between the panels within the panel array by taking up the tension while the tensioned panels are installed, and the array of panels is thus gaining tension. Otherwise, the array of panels would accumulate significant tension along one axis and the last frame would be difficult to install.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A greenhouse structural element, comprising:
a plurality of pretensioned panels, each panel comprising a transparent or translucent sheet that is stretched over a rigid frame when the panel is assembled and wherein said panels are configured for arrangement in panel arrays;
wherein during installation the panel is dropped in place within a rigid peripheral frame;
wherein tension across said pretensioned panel adds structural strength to the greenhouse; and
wherein a resulting assembly forms a tensile structure across a greenhouse surface.

2. The greenhouse structural element of claim 1, further comprising;
one or more connectors arranged to put tension between the panels by securing individual panels in said rigid peripheral frame when said panels are placed therein, as well as adjacent to each other along abutting edges thereof;
wherein said tension overcomes a tendency of the panels to bow inwardly and away from each other, and adds strength to a resulting structure while making the structure true and rectangular.

3-4. (canceled)

5. The greenhouse structural element of claim 1, wherein during prefabrication the panels are bowed inwardly due to the tension applied to the panel frame by the transparent or translucent sheet that is stretched across it; and
wherein said bowing is either corrected at the greenhouse site or the panels are mounted on a carrier that prevents them from bowing after initial assembly and during shipping.

6-9. (canceled)

10. The greenhouse structural element of claim 1, wherein said transparent or translucent sheet comprises two or more layers of material which include any of a pocket of air or an inert gas contained between the layers or disposed on one side of the layers.

11. A structural greenhouse panel, comprising:
a transparent or translucent sheet aligned with a rigid member and engaged with a transverse rigid member;
wherein the transparent or translucent sheet is wound about the rigid member to secure the transparent or translucent sheet to the rigid member; and
wherein the rigid member about which the transparent or translucent sheet is wound abuts the transverse rigid member to define a rectangular greenhouse panel.

12-14. (canceled)

15. The structural greenhouse panel of claim 11, wherein the transparent or translucent sheet is stretched to deform it in each of the horizontal and vertical dimensions;
wherein the transparent or translucent sheet does not return to its original shape after being stretched.

16-17. (canceled)

18. The structural greenhouse panel of claim 11,
wherein said panel frame comprises a series of rigid members that form a rectangle after the transparent or translucent material is wrapped around the members or otherwise secured to the rigid members;
wherein said rigid members comprise vertical bars that are relatively thin strips compared to the overall size of the rectangular panel;
wherein said rigid members do not function as a single frame; and
wherein when said rigid members are joined to an exterior frame and to each other they become regular rectangles that can collectively cover an entire surface of the greenhouse structure.

19. (canceled)

20. The structural greenhouse panel of claim 11, further comprising: a peripheral rigid frame;
wherein said a plurality of said panels are integrated into an assembly within said peripheral rigid frame by a plurality of connectors;
wherein said connectors connect one side of a panel to a next panel;
wherein said connectors connect said panels said peripheral rigid frame; and
wherein said connectors comprise any of fasteners, bolts with nuts, metallic rings, rivets, and wire.

21-23. (canceled)

24. The structural greenhouse panel of claim 20, wherein each panel stretches a panel next to it; and
wherein when the panels are installed in panes the panes stretch the panels to create a tensile surface across the whole frame in two dimensions.

25. (canceled)

26. The structural greenhouse panel of claim 20, wherein when the assemblies are installed, the tension applied traverses an entire surface of the greenhouse structure and holds the adjacent panels which are thereby pretensioned to pull each other into a true rectangle.

27. (canceled)

28. The structural greenhouse panel of claim 18, wherein said transparent or translucent sheet is secured to said rigid member by a heat weld;
wherein said transparent or translucent sheet comprises four edges:
wherein said transparent or translucent sheet is secured to rigid members on all four edges thereof;
wherein each edge of the transparent or translucent sheet is wrapped around a member that comprises either a rigid structure, or semi-rigid, or flexible structure;
wherein the transparent or translucent sheet is heat welded; and
wherein after it is heat welded the transparent or translucent sheet is wrapped one or more times around the member.

29-34. (canceled)

35. The structural greenhouse panel of claim 11, further comprising:
a U-shaped member supported by a framework that is configured to secure within a channel portion thereof the rigid members of two parallel panel assemblies.

36-37. (canceled)

38. The structural greenhouse panel of claim 35, wherein before the panels are installed, they are in a bowed configuration due to the tension of the transparent or translucent sheet from which they are formed; and
wherein said U-channel comprises a tensioning element that straightens said rigid members in the panels and finalizes the tension throughout the rest of the transparent or translucent sheet.

39-42. (canceled)

43. The structural greenhouse panel of claim 11, said rigid member further comprising:
a compound member to which said transparent or translucent sheet is secured;
wherein said compound member comprises a rigid metal bar that is partially surrounded by a molded plastic portion;
wherein said compound member comprises a bar comprising an elastomeric plastic cover that creates a soft edge for the transparent or translucent sheet to wrap around;
wherein said plastic cover either slips into a complementary depression formed within the metal bar or it is molded in contact with the metal bar;
wherein said plastic cover has a high coefficient of friction to prevent slippage of the transparent or translucent sheet;
wherein said metal bar provides rigidity, while said plastic cover mitigates the bending angle over which the transparent or translucent sheet is bent.

44-46. (canceled)

47. The structural greenhouse panel of claim 11, further comprising:
one or more blank panels made of a stiff material and that are installed in place of the panels having transparent or translucent sheet as blanks at a beginning of panel installation;
wherein after each of the panels having transparent or translucent sheet is installed in sequence a blank panel is removed and a panel having transparent or translucent sheet is installed in its place;
wherein the blank panels maintain a true relationship between the panels having transparent or translucent sheet within a panel array by taking up tension while tensioned panels having transparent or translucent sheet are installed.
